(19) United States
(12) Patent Application Publication
(10) Pub. No.: US 2024/0377714 A1
(43) Pub. Date: Nov. 14, 2024

(54) Dynamic camera

(71) Applicant: Kamal Bushnag, Knoxville, TN (US)

(72) Inventor: Kamal Bushnag, Knoxville, TN (US)

(21) Appl. No.: 18/629,565

(22) Filed: Apr. 8, 2024

Related U.S. Application Data
(60) Provisional application No. 63/465,037, filed on May 9, 2023.

(51) Int. Cl. G03B 17/56; F16M 11/12

(52) U.S. Cl. CPC G03B 17/561

(57) ABSTRACT

Apparatus for a dynamic camera having a motor driven rotating disc in which at least one rotating arm causes an imaging sensor to sweep a hemispherical field of view. Each rotating arm has one end attached to the rotating disc and the opposite end supporting an imaging module with at least one imaging sensor. Each rotating arm includes a rotation module, a swiveling module, and the imaging module. The rotation module selectively rotates a section of the arm that supports the swiveling module. The swiveling module includes a locking mechanism and a swiveling mechanism. The locking mechanism has a locked position that holds the imaging module in a center position. The swiveling mechanism, when the locking mechanism is unlocked, pivots the imaging module from the longitudinal axis of the rotating arm. The arm positions the imaging sensor so the sensor's optical axis is directed at desired areas.

### CROSS-REFERENCE TO RELATED APPLICATIONS

This application claims the benefit of U.S. Provisional Application No. 63/465,037, filed May 9, 2023.

### STATEMENT REGARDING FEDERALLY SPONSORED RESEARCH OR DEVELOPMENT

Not Applicable

### BACKGROUND

### 1. Field of Invention

This invention pertains to a dynamic camera system. More particularly, this invention pertains to a camera system in which the imaging sensor is movable in response to a control system.

### 2. Description of the Related Art

Cameras are included in many mobile and/or portable devices such as telephones, tablets, laptops, and some desktop computers. Generally, these camera have a fixed position and requirement movement of the mobile or portable device in order to aim the camera in a specific direction or at a specific object. That is, such cameras require manual operation by the person holding or controlling the device in order for the camera to view a specific object or in a specific direction.

Accordingly, it is desirable to have a camera that is dynamically controlled such that it has a wide field of view and can follow objects that are identified in that field of view.

### BRIEF SUMMARY

According to one embodiment of the present invention, a dynamic camera system is provided. The dynamic camera includes a camera assembly. The camera assembly includes a rotary drive connected to a rotating disc and at least one rotating arm. The rotary drive rotates the rotating disc and the at least one rotating arm in tandem. Each rotating arm includes a rotation module, a swiveling module, and an imaging module.

In one embodiment, the rotary drive includes a flat, spiral spring that applies force to a speed control device. The output of the speed control device drives the rotating disc and the at least one rotary arm. The spring is charged or wound by a solenoid.

In one embodiment, electrical connections to the at least one rotating arm are made by brushes contacting conductive traces on the bottom surface of the rotating disc. Electrical conductors connect the conductive traces to components on the at least one rotating arm that require electrical control and/or power.

In one embodiment, two rotating arms extend in opposite directions from a hub attached to the rotary drive. In another embodiment, four rotating arms extend at 90 degree intervals from a hub attached to the rotary drive.

Each rotating arm includes a fixed member, a rotating module, a rotating member, a swiveling module, a swiveling member, and at least one imaging module. The fixed member extends from the hub and is attached to a housing of the rotating module. The rotating member extends from the rotating module and connects to the swiveling module. The swiveling module includes a locking mechanism and a swiveling mechanism. The swiveling member extends from the swiveling mechanism and supports the at least one imaging module.

### BRIEF DESCRIPTION OF THE SEVERAL VIEWS OF THE DRAWINGS

The above-mentioned features will become more clearly understood from the following detailed description read together with the drawings in which:

FIG. 1 is a front view of one embodiment of a camera assembly with four rotating arms.

FIG. 2 is a side view of another embodiment of a camera assembly with two rotating arms.

FIG. 3 is a rear view one embodiment of a rotating disc showing a plurality of conductive traces.

FIG. 4 is a symbolic view of the degrees of freedom of the imaging module.

FIG. 5 is a side view of one embodiment of a rotary drive.

FIG. 6 is a plan view of one embodiment of the spring for the embodiment of the rotary drive of FIG. 5.

FIG. 7 is a plan view of a first embodiment of a rotation module for the rotating arm.

FIG. 8 is a cross-sectional view of a first embodiment of a rotating member for the first embodiment of the rotation module.

FIG. 9 is a plan view of a second embodiment of a rotation module for the rotating arm.

FIG. 10 is a cross-sectional view of a second embodiment of a rotating member for a second embodiment of the rotation module.

FIG. 11 is a plan view of one embodiment of a swiveling module including one embodiment of a locking mechanism and one embodiment of a swiveling mechanism in the center position.

FIG. 12 is a plan view of one embodiment of the slotted bushing for the swiveling mechanism.

FIG. 13 is a plan view of the swiveling module of FIG. 8 showing the locking mechanism and the swiveling mechanism in the left-actuated position.

FIG. 14 is a functional block diagram of the electrical connections of the camera assembly.

FIG. 15 is a symbolic side view of one embodiment of the camera assembly showing the field of view.

FIG. 16 is a symbolic front view of one embodiment of the camera assembly showing the field of view.

FIG. 17 is a functional flow block diagram of the steps for keeping an object within a field of view of the camera assembly.

### DETAILED DESCRIPTION

Apparatus for a dynamic camera assembly 100 is disclosed. The camera assembly is generally indicated as 100, with particular embodiments and variations shown in the figures and described below having an alphabetic suffix, for example, 100-A, 100-B. Various components are illustrated both generically and specifically in the figures and in the following description. For example, the rotating arms 104-A, 104-B, 104-C, 104-D are discussed individually and separately to ensure clarity when describing the configuration of each rotating arm 104-A, 104-B, 104-C, 104-D. The rotating arms 104, when referred to collectively, are referenced without the alphanumeric suffix. Various embodiments of components and elements are shown with and without a following prime, such as the rotation module 120, 120′.

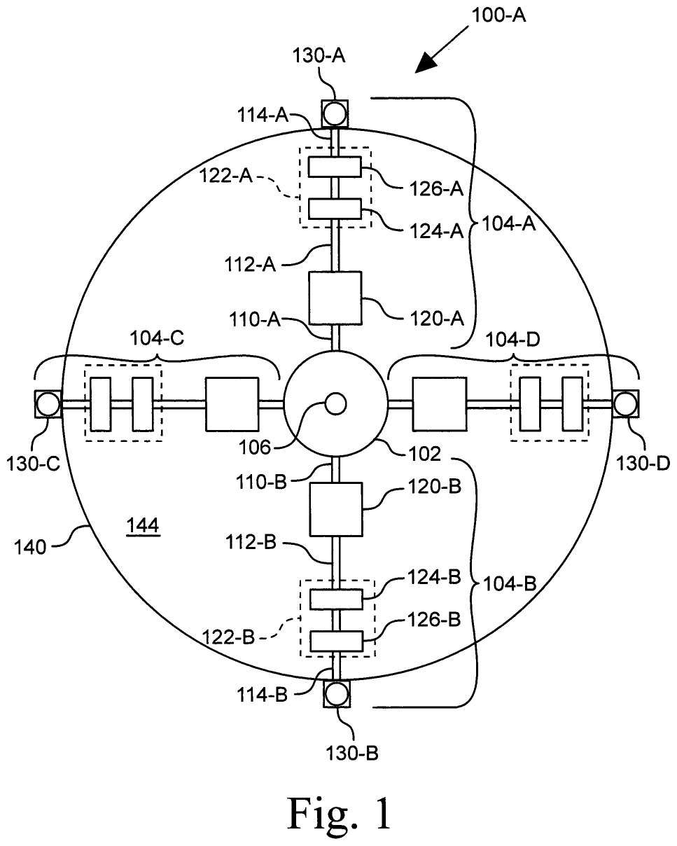

Directional or positional references, for example, front, rear, upper, lower, left, right, horizontal, vertical, apply to the orientation as displayed in the subject figure. For example, the camera assembly 100-A illustrated in FIG. 1 is shown with the front face visible.

The following table lists the various components that first appear in each figure.

| | |
|---|---|
| Ref. Number | Description |

FIG. 1

| | |
|---|---|
| 100 | Camera assembly that includes the camera sensor and the |
| | positioning components |
| 100-A | An embodiment of the camera assembly with four rotating arms |
| | 104-A, -B, -C, -D |
| 100-B | An embodiment of the camera assembly with two opposing rotating |
| | arms 104-A, -B |
| 102 | Hub for the rotating arm 104 |
| 104-A, -B, -C, -D | Rotating arm that includes the shaft 112, the rotation module |
| | 132, the angle positioning module 134, and the imaging module 110 |
| 106 | Shaft of the rotary drive 202 |
| 110-A, -B, -C, -D | Fixed member of the rotating arm 104 |
| 112-A, -B, -C, -D | Rotating member of the rotating arm 104 |
| 114-A, -B, -C, -D | Swiveling member of the rotating arm 104 |
| 120-A, -B, -C, -D | Rotation module that rotates the rotating member 112 of the |
| | rotating arm 104 |
| 122-A, -B, -C, -D | Swiveling module that swivels the swiveling member 114 of the |
| | rotating arm 104 |
| 124-A, -B, -C, -D | Locking or latching mechanism for the swiveling module 122 |
| 126-A, -B, -C, -D | Swiveling mechanism for the swiveling module 122 |
| 130-A, -B, -C, -D | Imaging module including the imaging sensor and lens |
| 140 | Rotating disc |
| 144 | Top surface of the rotating disc 140 |

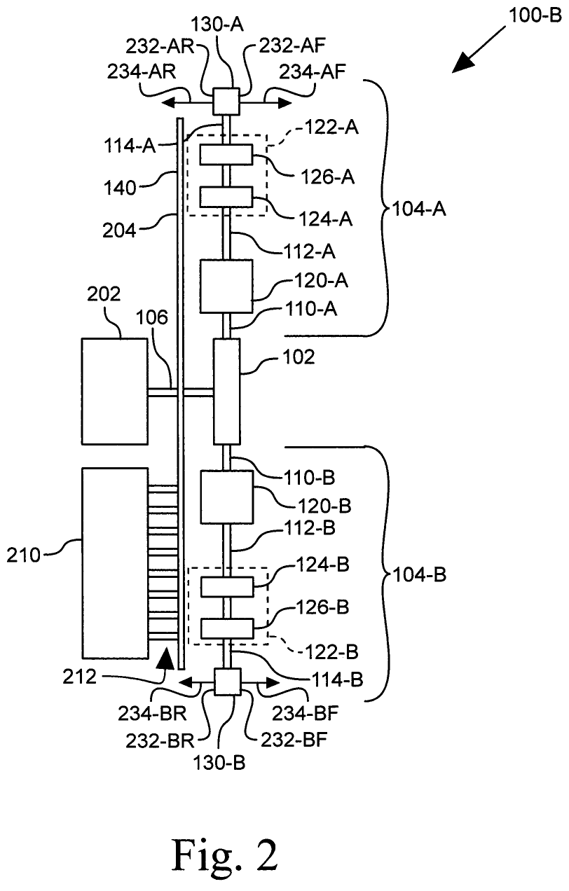

FIG. 2

| | |
|---|---|
| 202 | Rotary drive |
| 204 | Bottom surface of the rotating disc 140 |
| 210 | Brush support |
| 212 | Brushes contacting conductive traces 302 on the bottom surface |
| | 240 of the rotating disc 140 |
| 232-AF, -AR, | Front and Rear imaging sensors |
| 232-BF, -BR | |
| 234-AF, -AR, | Front and rear facing imaging sensor optical axis |
| 234-BF, -BR | |

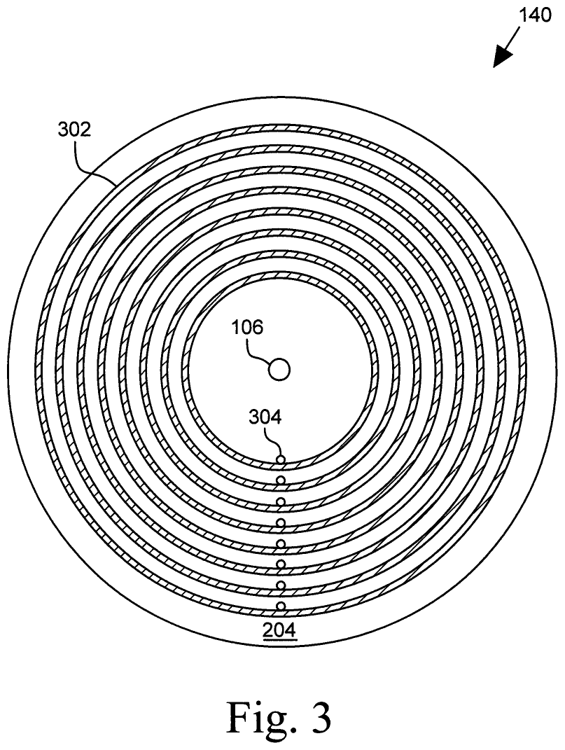

FIG. 3

| | |
|---|---|
| 302 | Conductive traces on the bottom surface 240 of the rotating disc 140 |
| 304 | Plated through-holes in rotating disc 140 |

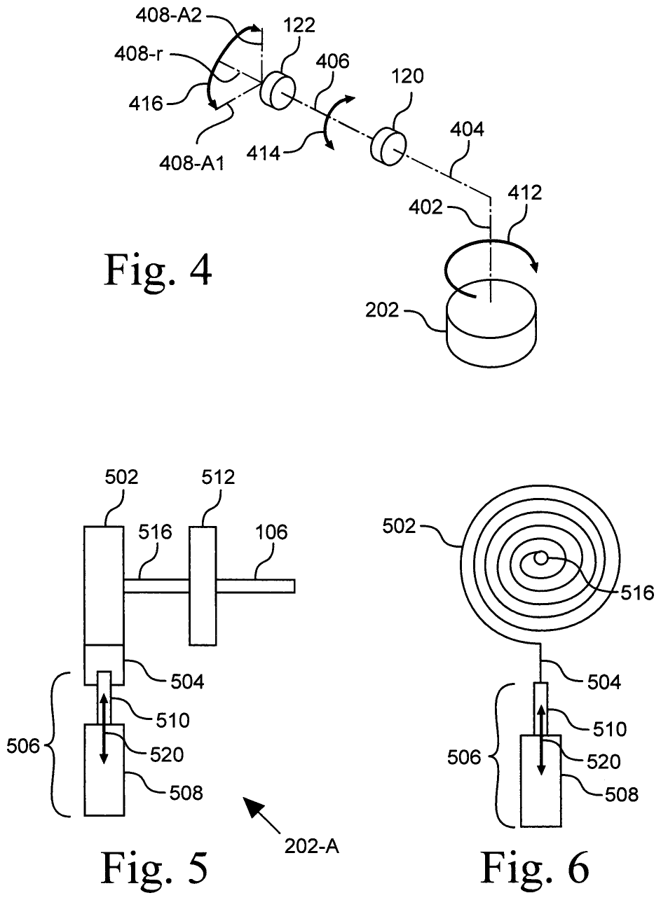

FIG. 4

| | |
|---|---|
| 402 | Axis of rotation of the rotary drive 202 |
| 404 | Longitudinal axis of the rotating arm 104 |
| 406 | Longitudinal axis of the rotating member 112 of the rotating arm 104 |
| 408 | Swiveling axis of the swiveling member 114. The swiveling axis 408 |
| | has a resting position 408-r and extreme positions 408-A1, 408-A2 |
| 412 | Direction of rotation of the shaft 106 of the rotary drive 202 |
| 414 | Direction of rotation of the rotating member 112 of the rotating arm 104 |
| 416 | Direction of arc traversed by the imaging module 130 at the end of |
| | the swiveling member 114 of the rotating arm 104 |

FIG. 5

| | |
|---|---|
| 202-A | Rotary drive embodiment with spring 502 |
| 502 | Flat, coil spring |
| 504 | Connector between the spring 502 and the solenoid plunger 510 |
| 506 | Solenoid for the rotary drive 202-A |
| 508 | Solenoid actuator for the rotary drive solenoid 506 |
| 510 | Solenoid plunger for the rotary drive solenoid 506 |
| 512 | Speed control device for the rotary drive 202-A |
| 516 | Shaft connecting spring 502 to speed reducer 512 |
| 520 | Direction of the solenoid plunger 510 movement when actuated |

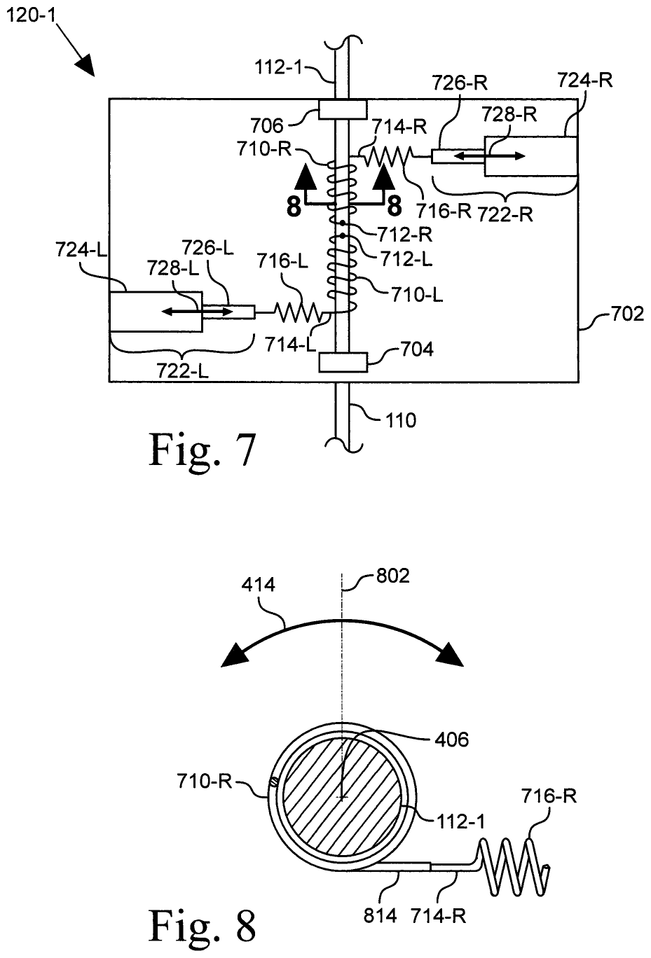

FIG. 7

| | |
|---|---|
| 702 | Housing for the rotation module 120 that rotates the rotating |
| | member 112 of the rotating arm 104 |
| 704 | Distal bearing for the rotating member 112 of the rotating arm 104 |
| 706 | Medial bearing for the rotating member 112 of the rotating arm 104 |
| 710-R, -L | Right and Left axial springs |
| 712-R, -L | Distal end of axial spring 710 |
| 714-R, -L | Free end of axial spring 710 |
| 716-R, -L | Expansion spring |
| 722-R, -L | Right and Left solenoids for the rotation module 120 |
| 724-R, -L | Solenoid actuator for the rotation module solenoid 722 |
| 726-R, -L | Solenoid plunger for the rotation module solenoid 722 |
| 728-R, -L | Direction of solenoid plunger 726 movement when actuated |

FIG. 8

| | |
|---|---|
| 802 | Resting axis perpendicular to longitudinal axis 406 of the rotating |
| | member 112-1 of the rotating arm 104 |
| 814-R, | Extension from axial spring 710-R to free end 714-R of expansion |
| | spring 716-R |

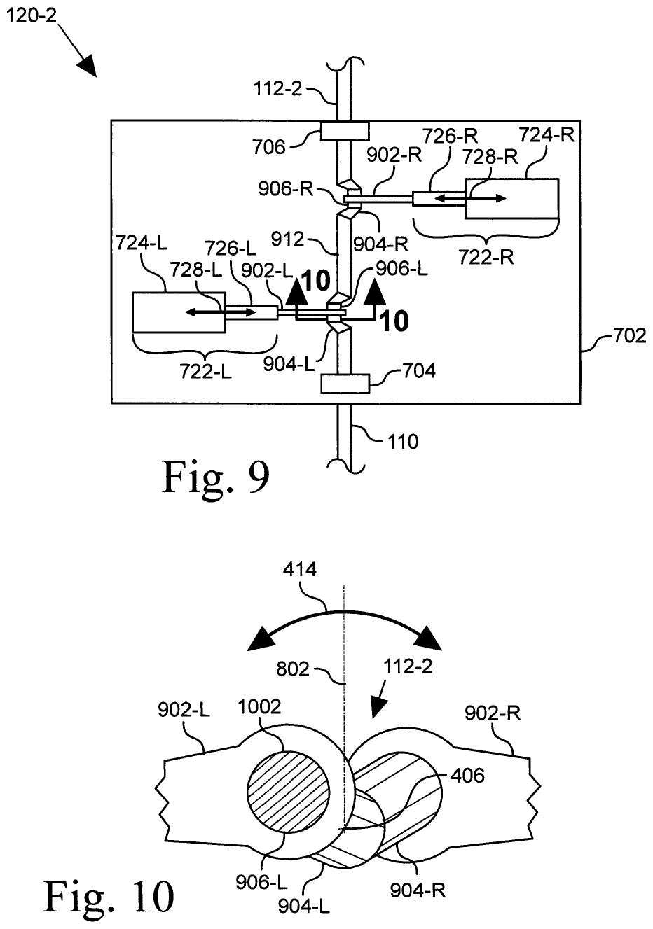

FIG. 9

| | |
|---|---|
| 902-R, -L | Connecting rod between solenoid plunger 726 and the rotating |
| | member 112-2 of the rotating arm 104 |
| 904-R, -L | Crank web for crankshaft (rotating member 112-2) |
| 906-R, -L | Crank pin for crankshaft (rotating member 112-2) |
| 912 | Shaft |

FIG. 10

| | |
|---|---|
| 1002 | Opening in connecting rod 902 |

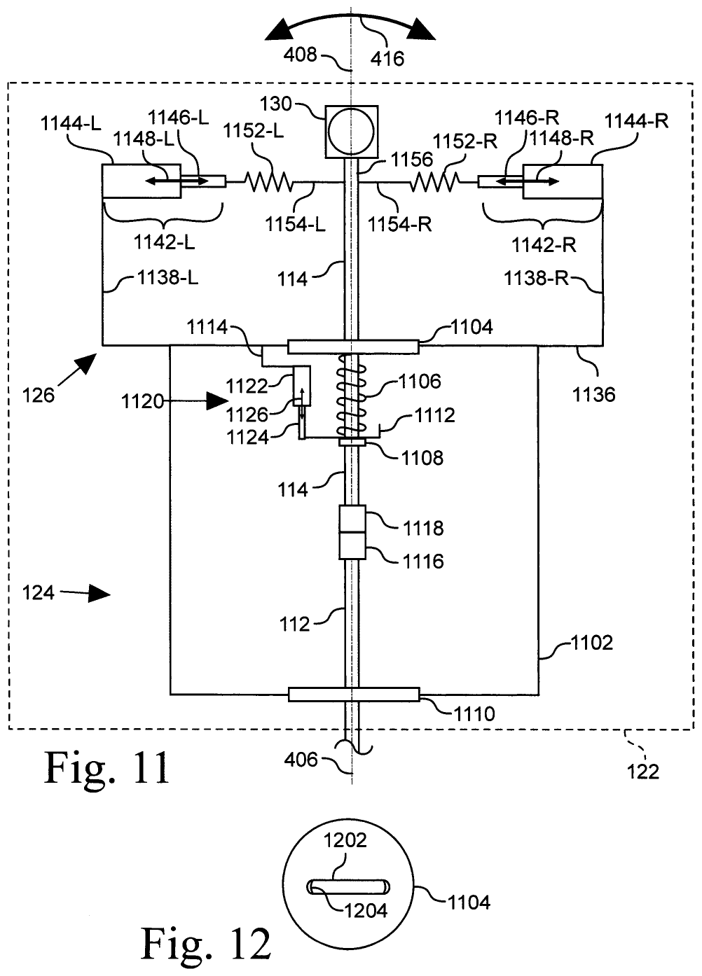

FIG. 11

| | |
|---|---|
| 1102 | Housing for the locking mechanism 124 of the swiveling module 122 |
| 1104 | Slotted bushing for the locking mechanism 124 |
| 1106 | Spring to bias the swiveling member 114 toward the rotating |
| | member 112 |
| 1108 | Stop connector fixed to the swiveling member 114 and the push-up |
| | bracket 1112 |
| 1110 | Fastener securing the rotating member 112 to the housing 1102 |
| 1112 | Bracket connected to solenoid plunger 1124 and stop connector 1108 |
| 1114 | Holder for the solenoid actuator 1122 |
| 1116 | First magnet attached to end of the rotating member 112 |
| 1118 | Second magnet attached to the swiveling member 114. The mating |
| | faces of the first and second magnets 1116, 1118 have opposing |
| | polarities such that the first and second magnets 1116, 1118 are |
| | attracted to each other. |
| 1120 | Solenoid for the latching mechanism 124 |
| 1122 | Solenoid actuator for the latching mechanism solenoid 1120 |
| 1124 | Solenoid plunger for the latching mechanism solenoid 1120 |
| 1126 | Direction of solenoid plunger 1124 movement when actuated |
| 1136 | Housing for the swiveling mechanism 126 of the swiveling module 122 |
| 1138-R, -L | Right and left sidewalls of housing 1136 for the swiveling |
| | mechanism 126 |
| 1142-L, -R | Left and Right solenoids for the swiveling mechanism 126 |
| 1144-L, -R | Solenoid actuator for the swiveling mechanism 126 |
| 1146-L, -R | Solenoid plunger for the swiveling mechanism 126 |
| 1148-L, -R | Direction of solenoid plunger 1146 movement when actuated |
| 1152-L, -R | Expansion spring |
| 1154-L, -R | Link between expansion spring 152-L, 152-R and swiveling |
| | member 114 |
| 1156 | Distal end of the swiveling member 114 |

FIG. 12

| | |
|---|---|
| 1202 | Outer slot opening |
| 1204 | Inner slot opening (the inner slot opening 1204 is not as wide as |
| | the outer slot opening 1202 to allow for the tilting of the swiveling |
| | member 114 |

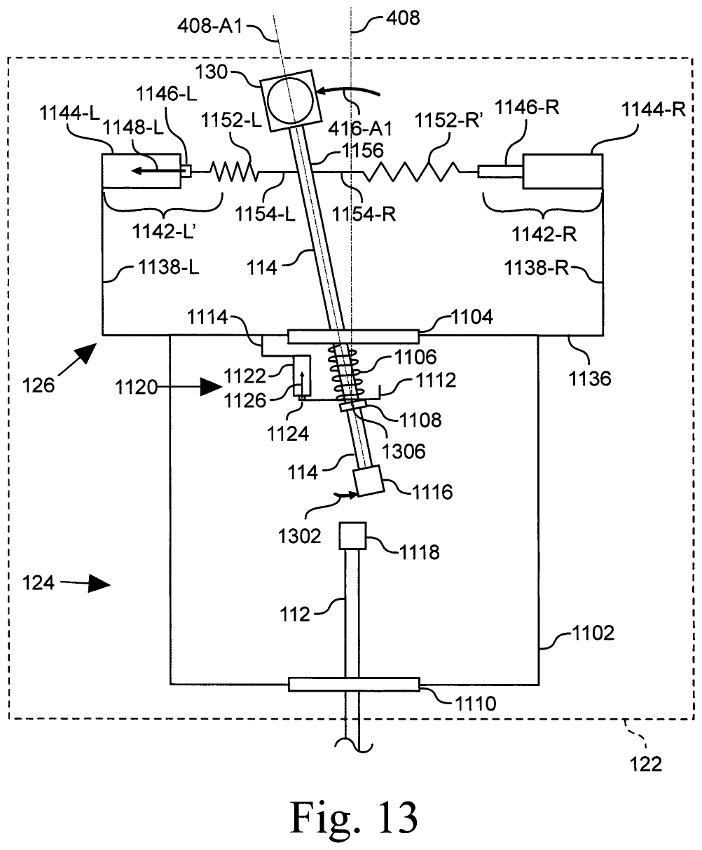

FIG. 13

| | |
|---|---|
| 1302 | Direction of movement of first magnet 812 when swiveling module |
| | 122 is actuated leftward |
| 416-A1 | Direction of movement of imaging module 130 when the swiveling |
| | module 122 is actuated leftward |
| 1306 | Pivot for the swiveling member 114 when the swiveling module |
| | 122 is actuated |

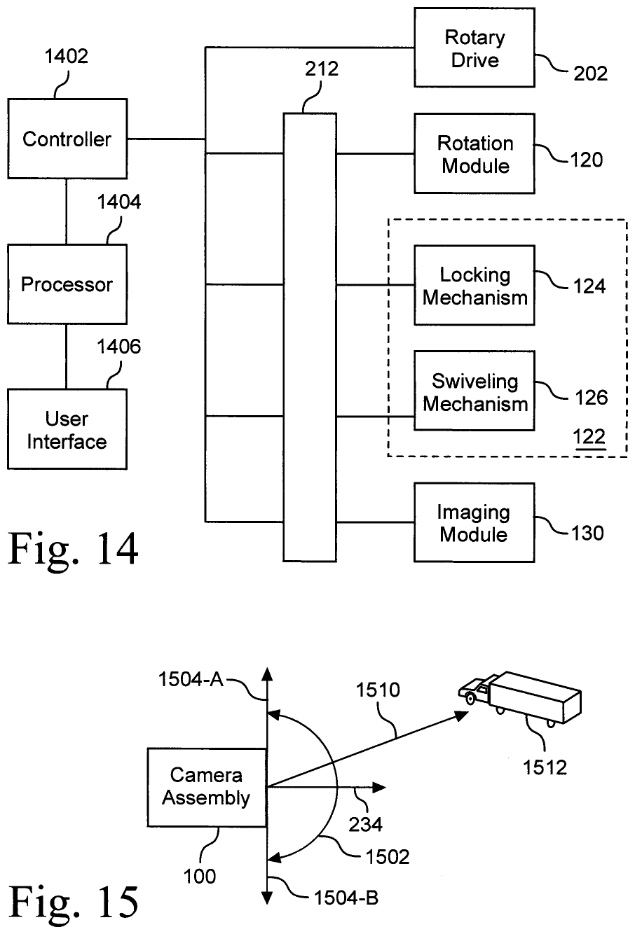

FIG. 14

| | |
|---|---|
| 1402 | Controller |
| 1404 | Processor |
| 1406 | User interface |

FIG. 15

| | |
|---|---|
| 1502 | Field of view |
| 1504-A, -B | Extreme directions of optical axis 234 due to operation of the |
| | camera assembly 100 |
| 1510 | Line of sight to object 1512 |
| 1512 | Object within field of view 1502 of the camera assembly 100 |

FIG. 17

| | |
|---|---|
| 1702 | Start step |
| 1710 | Step to identify object |
| 1720 | Step to determine if object 1512 is in field of view 1502 |
| 1730 | Step to move optical axis 234 |
| 1740 | Step to wait a selected time |

FIG. 1 illustrates a front view of one embodiment of a camera assembly 100-A with four rotating arms 104-A, 104-B, 104-C, 104-D. FIG. 4 illustrates a symbolic view of the degrees of freedom of each imaging module 130.

The camera assembly 100-A includes four imaging modules 130-A, 130-B, 130-C, 130-D, each mounted on the distal end of a respective rotating arm 104-A, 104-B, 104-C, 104-D. Each rotating arm 104 is attached to a hub 102 that rotates the arms 104 about a shaft 106 with a rotary motion 412. Behind the hub 102 and the arms 104, is a rotating disc 140 that rotates in conjunction and in sync with the rotating arms 104. The front surface 144 of the rotating disc 140 is proximate to the rotating arms 104. That is, the front surface 144 of the rotating disc 140 is facing the rotating arms 104.

Each rotating arm 104 includes a fixed member 110 extending from the hub 102. The following describes the rotating arms 104-A, 104-B that are on opposite sides of the hub 102. For the illustrated embodiment with four rotating arms 104-A, 104-B, 104-C, 104-D positioned at 90 degree intervals around the hub 102, the other two rotating arms 104-C, 104-D are substantially the same as the two arms 104-A, 104-B described herein. Each of the fixed members 110-A, 110-B are held in a fixed orientation relative to the hub 102, the rotation module 120-A, 120-B, and the rotating disc 140.

Each rotating arm 104-A, 104-B includes a rotating member 112-A, 112-B extending between each of the rotation modules 120-A, 120-B and each of the swiveling modules 122-A, 122-B. The longitudinal axis 406 of the rotating member 112 is coaxial with the longitudinal axis 404 of the fixed member 110. The rotating arm 112 has a rotary motion 414 relative to the longitudinal axis 404 of the fixed member 110.

Each rotating arm 104-A, 104-B includes a swiveling member 114-A, 114-B extending between each of the swiveling modules 122-A, 122-B and each of the imaging modules 130-A, 130-B. The swiveling member 114 has a resting position with a longitudinal axis 408-r coaxial with the longitudinal axis 406 of the rotating member 112 and the longitudinal axis 404 of the fixed member 110. The swiveling member 114 has a longitudinal axis 408 that moves between extreme positions 408-A1, 408-A2 with a swiveling motion 416.

Each swiveling module 122-A, 122-B includes a locking or latching mechanism 124-A, 124-B and a swiveling mechanism 126-A, 126-B. The locking mechanism 126 locks the swiveling member 114 into a resting position where the longitudinal axis 408-r is coaxial with the longitudinal axis 406 of the rotating member 112 and the longitudinal axis 404 of the fixed member 110. When unlocked, the locking mechanism 126 allows the swiveling member 114 to swivel such that longitudinal axis 408 of the swiveling member 114 moves between extreme positions 408-A1, 408-A2 with a swiveling motion 416.

Each rotating arm 104-A, 104-B includes an imaging sensor 130-A, 130-B at the distal end of each one of the swiveling members 114-A, 114-B. As illustrated in FIG. 2, each imaging sensor 130-A, 130-B includes a front sensor 232-AF, 232-BF and a rear sensor 232-AR, 232-BR. Each front and rear sensor 232-R, 232-R includes an optical lens and a sensor array that is responsive to light.

FIG. 2 illustrates a side view of another embodiment of a camera assembly 100-B with two rotating arms 104-A, 104-B. The illustrated embodiment of the camera assembly 100-B is similar to the embodiment of the assembly 100-A shown in FIG. 1 except that there are only two rotating arms 104-A, 104-B. The two rotating arms 104-A, 104-B are on opposing sides of the hub 102. Each rotating arm 104-A, 104-B includes a fixed member 110-A, 110-B extending from the hub 102, a rotation module 120-A, 120-B, a rotating member 104-A, 104-B, a swiveling module 122-A, 122-B, a swiveling member 114-A, 114-B, and an imaging module 130-A, 130-B.

Each imaging module 130-A, 130-B includes a front facing sensor 232-AF, 232-BF and a rear facing sensor 232-AR, 232-BR. The front facing sensors 232-AF, 232-BF each have a respective front facing imaging sensor optical axis or view direction 234-AF, 234-BF. The rear facing sensors 232-AR, 232-BR each have a respective rear facing imaging sensor optical axis or view direction 234-BR, 234-BR. Those skilled in the art will recognize that the sensors 232 include the necessary optical lenses to provide the desired field-of-view and depth of focus as desired for a particular application of the camera assembly 100 without departing from the spirit and scope of the present invention.

The hub 102 is connected to a rotary drive 202 by way of the axel 106. In the illustrated embodiment, the rotating disc 140 is attached to the axel 106 and rotates in sync with the hub 102 and the rotating arms 104. In another embodiment, the rotating disc 140 is attached to hub 102, thereby rotating in sync with the rotating arms 104.

FIG. 3 illustrates a rear view one embodiment of a rotating disc 140 showing a plurality of conductive traces 302. The rotating disc 140 has a back or bottom surface 204 that faces the rotary drive 202. A series of brushes 212 each make electrical contact with one of a series of conductive traces 302 on the bottom surface 204 of the rotating disc 140. A brush support 210 holds the series of brushes 212 in alignment with the conductive traces 302 and further biases the brushes 212 against the bottom surface 204 so as to maintain a low resistance electrical connection with the conductive traces 302.

The conductive traces 302 are concentrically centered relative to the axel 106. The conductive traces 302 are in electrical communication through the rotating disc 140 such that electrical an electrical connection is maintained between the conductive traces 302 and the individual electrical components on the rotating arms 104. In the illustrated embodiment, plated through-holes 304 provide an electrically conductive path from the adjacent conductive trace 302 on the bottom surface 204 of the rotating disc 140 to the top surface of the rotating disc 140. In one such embodiment, the rotating disc 140 is a printed circuit board with the conductive traces 302 on the bottom surface 204 and plated through-holes 304 providing a conductive path to the top surface 144 of the rotating disc 140.

FIG. 4 illustrates a symbolic view of the degrees of freedom of each imaging module 130 relative to a fixed reference of the rotary drive 202. The rotary drive 202 has a fixed reference at the longitudinal axis 402 of the shaft 106. The shaft 106 rotates in a rotary direction 412. Each rotating arm 104 rotates in conjunction with the shaft 106 such that each rotary arm 104 swings in the rotary direction 412. For the embodiment where each rotating arm 104 extends perpendicular to the shaft 106, each rotating arm 104 rotates in conjunction with the shaft 106 such that each rotary arm 104 swings in the rotary direction 412 in a plane perpendicular to the shaft 106.

The rotating arm 104 has a longitudinal axis 404 that is coaxial with the fixed member 110, the rotating member 112, and the swiveling member 114 when the swiveling member 114 is in the resting or normal position. The rotating member 112 of the rotating arm 104 is positioned between the rotation module 120 and the swiveling module 122. The rotating member 112 and the swiveling member 114 rotate in a rotary direction 414 about the longitudinal axis 404 of the rotating arm 104.

The swiveling member 114 of the rotating arm 104 is positioned between the swiveling module 122 and the imaging module 130. In the resting position, the swiveling member 114 has a longitudinal axis 408. In one embodiment, the swiveling member 114 swivels between two extreme positions such that the swiveling member 114 has a first and second positioned longitudinal axis 408-A1, 408-A2 whereby the imaging module 130 moves in an arcuate direction 416.

When the swiveling module 122 is actuated and as the rotating member 120 operates to rotate the rotating member 112, the first and second positioned longitudinal axis 408-A1, 408-A2 traverse a conical path with the imaging sensor optical axis 234 being perpendicular to the swiveling longitudinal axis 408.

With the imaging module 130 moving in the various directions 412, 414, 416, the imaging sensor 132 optical axis 234 is directed in various directions. In this way, the camera assembly 100 provides images of a large portion of its surrounding environment.

FIG. 5 illustrates a side view of one embodiment of a rotary drive 202-A. FIG. 6 illustrates a plan view of one embodiment of the spring 502 for the embodiment of the rotary drive 202-A of FIG. 5. In one embodiment of the illustrated embodiment, the spring-driven rotary drive 202-A operates similarly to that of a watch with a spring drive. In another embodiment, the spring-driven rotary drive 202-A operates similarly to that of a watch with an escarpment that regulates the rotary speed of the shaft 106.

The rotary drive 202-A includes a spring 502, a solenoid 506, and a speed control device 512. The rotary drive 202-A includes the shaft 106 that connects the rotary motion 412 produced by the rotary drive 412 to the rotating disc 140 and hub 102, such as illustrated in FIG. 2.

In the illustrated embodiment, the spring 502 is a flat, coil spring with one end connected to a shaft 516 and the other end being a connector 504 attached to the solenoid 506. The shaft 516 is operatively connected to the speed control device 512, which is operatively connected to the shaft 106. The speed control device 512 converts the rotary force of the spring 502 into a controlled, regular rotary motion 412. In various embodiments, the speed control device 512 is one of a spring drive or an escarpment.

The solenoid 506 includes a solenoid actuator 508 that causes a solenoid plunger 510 to reciprocate linearly. In the illustrated embodiment, upon actuation, such as when energized, the plunger 510 moves in the direction 520 toward the actuator 508. Upon de-actuation, such as when deenergized, the plunger 510 moves oppositely of the direction 520 away the actuator 508. Such outward movement is by an integral spring force that is overcome when the actuator 508 is actuated. In another embodiment, the actuator 508 is double acting such that the actuator 508 forces movement of the plunger 510 inward and outward depending upon how the actuator 508 is energized. A person skilled in the art will recognize that the movement of the plunger 510 can be controlled in various ways without departing from the spirit and scope of the present invention.

FIG. 7 illustrates a plan view of one embodiment of a rotation module 120-1 for the rotating arm 104. FIG. 8 illustrates a cross-sectional view of a first embodiment of a rotating member 112-1 for the first embodiment of the rotation module 120-1. The rotation module 120-1 includes a housing 702, a distal bearing 704 and a medial bearing 706 engaging the rotating member 112-1 of the rotating arm 104, right and left axial springs 710-R, 710-L, expansion springs 716-R, 716-L, and right and left solenoids 722-R, 722-L.

The housing 702 of the illustrated embodiment of the rotation module 120-1 is affixed to the distal end of the fixed member 110 of the rotating arm 104. In this way, the housing 702 is stationary relative to the fixed member 110, which rotates about the hub 102. A portion of the rotating member 112-1 of the rotating arm 104 extends into the housing 702. The distal end of the rotating member 112-1, which is proximate the end of the fixed member 110, is supported by the distal bearing 704. The rotating member 112-1 at the opposite end of the housing 702 from where the fixed member 110 is affixed is supported by the medial bearing 706. The two bearings 704, 706 support the rotating member 112-1 and allow the rotating member 112-1 to rotate 414 about the longitudinal axis 406 of the rotating member 112-1.

The rotation module 120-1 has an input connected to the fixed member 110. The rotation module 120-1 has an output connected to the rotating member 112-1. The output rotates 414 about the longitudinal axis 404 of the rotating arm 104.

The rotating member 112-1 is caused to rotate in one direction 414 by the right solenoid 722-R. The right solenoid 722-R includes a right actuator 724-R and a right plunger 726-R. The distal end of the plunger 726-R is attached to one end of an expansion spring 716-R. The opposite end 714-R of the expansion spring 716-R is attached to the free end 814 of an axial spring 710-R. The axial spring 710-R is coaxial with the rotating member 112-1 with the opposite end 712-R of the axial spring 710-R affixed to the rotating member 112-1. The plunger 726-R reciprocates linearly. In the illustrated embodiment, upon actuation, such as when energized, the plunger 726-R moves in the direction 728-R toward the actuator 724-R. Upon de-actuation, such as when deenergized, the plunger 726-R moves oppositely of the direction 728-R away the actuator 724-R. Such outward movement is by an integral spring force that is overcome when the actuator 724-R is actuated. In another embodiment, the actuator 724-R is double acting such that the actuator 724-R forces movement of the plunger 726-R inward and outward depending upon how the actuator 724-R is energized. A person skilled in the art will recognize that the movement of the plunger 726-R can be controlled in various ways without departing from the spirit and scope of the present invention.

The rotating member 112-1 is caused to rotate in the opposite direction 414 by the left solenoid 722-L. The left solenoid 722-L includes a left actuator 724-L and a left plunger 726-L. The distal end of the plunger 726-L is attached to one end of an expansion spring 716-L. The opposite end 714-L of the expansion spring 716-L is attached to the free end 814 of an axial spring 710-L. The axial spring 710-L is coaxial with the rotating member 112-1 with the opposite end 712-L of the axial spring 710-L affixed to the rotating member 112-1. The left axial spring 710-L is oriented oppositely with respect to the right axial spring 710-R such that actuation of the left solenoid 722-L rotates the rotating member 112-1 in the opposite direction 414 relative to when the right solenoid 722-R is actuated. The plunger 726-L reciprocates linearly. In the illustrated embodiment, upon actuation, such as when energized, the plunger 726-L moves in the direction 728-L toward the actuator 724-L. Upon de-actuation, such as when deenergized, the plunger 726-L moves oppositely of the direction 728-L away the actuator 724-L. Such outward movement is by an integral spring force that is overcome when the actuator 724-R is actuated. In another embodiment, the actuator 724-L is double acting such that the actuator 724-L forces movement of the plunger 726-L inward and outward depending upon how the actuator 724-L is energized. A person skilled in the art will recognize that the movement of the plunger 726-L can be controlled in various ways without departing from the spirit and scope of the present invention.

In operation, the solenoids 722-R, 722-L are actuated one-at-a-time based on the desired direction of rotation 414. The resting position of the rotating member 112-1 is illustrated in FIG. 8 with the resting axis 802 being perpendicular to the longitudinal axis 406 of the rotating member 112-1 and perpendicular to the rotating disc 140. The resting axis 802 is coplanar with the imaging sensor optical axis 234 with the imaging modules 130 in the resting position 408-r.

When the right solenoid 722-R is actuated, The plunger 726-R moves inward 728-R, tensioning the expansion spring 716-R and causing the axial spring 710-R to engage the rotating member 112-1, thereby rotating the rotating member 112-1. As a consequence of the member 112-1 rotating, the left expansion spring 716-L rotates and compresses the expansion spring 716-L. Because the left solenoid 722-L is not actuated, the left plunger 726-L is in its resting position, that is, it is positioned fully inward 728-L. When the member 112-1 is rotated in the opposite direction 414, the process is the same except “right” and “left” are exchanged.

FIG. 9 illustrates a plan view of a second embodiment of a rotation module 120-2 for the rotating arm 104. FIG. 10 illustrates a cross-sectional view of a second embodiment of a rotating member 112-2 for the second embodiment of the rotation module 120-2.

The illustrated embodiment of the rotation module 120-2 includes a rotating member 112-2 that has a crankshaft configuration with a pair of solenoids 722-R, 722-L driving connecting rods 902-R, 902-L that engage crank pins 906-R, 906-L. The shaft 912 of the crankshaft 112-2 defines the longitudinal axis 406 of the rotating member 112-2, which is the axis 406 of rotation for the crankshaft 112-2. The illustrated resting position shows the resting axis 802 being perpendicular to the longitudinal axis 406 of the rotating member 112-1 and perpendicular to the rotating disc 140.

In the illustrated embodiment, two solenoids 722-R, 722-L engage the crankshaft 112-2, causing the crankshaft 112-2 to rotate 414. A right solenoid 722-R includes an actuator 724-R with a plunger 726-R attached to a connecting rod 902-R. The distal end of the connecting rod 902-R has an opening 1002 that encircles the crank pin 906-R such that the connecting rod 902-R rotates freely around the crank pin 906-R. The crank pin 906-R is offset from the shaft 912 by a pair of crank webs 904-R. A left solenoid 722-L includes an actuator 724-L with a plunger 726-L attached to a connecting rod 902-L. The distal end of the connecting rod 902-L has an opening 1002 that encircles the crank pin 906-L such that the connecting rod 902-L rotates freely around the crank pin 906-L. The crank pin 906-L is offset from the shaft 912 by a pair of crank webs 904-L. The offset is such that that linear motion 728-R, 728-L of the plunger 726-R, 726-L applies a force to the crankshaft 112-2 that causes the crankshaft 112-2 to rotate 414.

The offset of the two crank pins 906-R, 906-L is such that alternating operation of the two solenoids 722-R, 722-L forces the crankshaft 112-2 to rotate 414. In particular, the angle defined by lines passing through the longitudinal axis 406 and the center of each crank pin 906-R, 906-L is less than 180 degrees.

In another embodiment, three solenoids 722 each engage a crank pin 906 that are spaced at 120 degree intervals around the longitudinal axis 406. In such an embodiment, the crankshaft 112-2 is able to rotate 360 degrees around the longitudinal axis 406, thereby allowing a single imaging sensor 232 to have a field of view that traverses an arc 416 of 360 degrees.

FIG. 11 illustrates a plan view of one embodiment of a swiveling module 122 including one embodiment of a locking mechanism 124 and one embodiment of a swiveling mechanism 126 in the center position. The locking mechanism 124 is illustrated in the locked position with the first and second magnets 1116, 1118 having opposing poles in contact. The swiveling mechanism 126 is illustrated in the center position with the imaging module 130 aimed in the resting position 408-r of the swiveling axis 408 with the resting axis 408-r perpendicular to the rotating disc 140. FIG. 12 illustrates a plan view of one embodiment of the slotted bushing 1104 for the swiveling mechanism 126.

The illustrated embodiment of the locking mechanism 124 includes a housing 1102 that includes a fastener 1110 that secures the housing 1102 to the rotating member 112. The distal end of the rotating member 112 includes a first magnet 1116 with the north and south poles aligned with the longitudinal axis 406 of the rotating member 112. Adjacent the first magnet 1116 is a second magnet 1118 attached to an end of the swiveling member 114 of the rotating arm 104. The north and south poles of the second magnet 1118 are aligned with the longitudinal axis 408 of the swiveling member 114. The first and second magnets 1116, 1118 are oriented such that opposing poles are proximate such that, when the magnets 1116, 1118 are in contact, the magnets 1116, 1118, and consequently, the rotating member 112 and the swiveling member 114 are locked together.

A latching mechanism solenoid 1120 is secured to the housing 1102 by way of a bracket 1114. The solenoid 1120 is located at the opposite end of the housing 1102 as the fastener 1110. The solenoid 1120 includes a solenoid actuator 1122 and a plunger 1124 that moves in a linear direction 1126. The distal end of the plunger 1124 is attached to a bracket 1112. The bracket 1112 is attached to a stop connector 1108. The bracket 1112 moves linearly along the longitudinal axis 408 of the swiveling member 114 in conjunction with the movement 126 of the plunger 1124.

The stop connector 1108 is affixed to the swiveling member 114. Disposed between the stop connector 1108 and a slotted bushing 1104 is a spring 1106. The spring 1106 biases the stop connector 1108 toward the rotating member 112 such that when the latching mechanism solenoid 1120 is not actuated, the first and second magnets 1116, 1118 are forced together, thereby latching the rotating member 112 to the swiveling member 114.

In operation, when the latching mechanism solenoid 1120 is actuated, the plunger 1124 moves inward toward the solenoid actuator 1122. The bracket 1112 moves in conjunction with the plunger 1124, moving the stop connector 1108 toward the bushing 1104 and separating the first and second magnets 1116, 1118. The swiveling member 114 is then free to move as directed by the swiveling mechanism 126. When the latching mechanism solenoid 1120 is de-actuated, the plunger 1124 returns to its resting position, which allows the first and second magnets 1116, 1118 to make contact and lock the rotating member 112 to the swiveling member 124.

The illustrated embodiment of the swiveling mechanism 126 includes a housing 1136 attached to the housing 1102 for the locking mechanism 124. The two housings 1102, 1136 move in concert with the rotating member 112. The connection between the locking mechanism 124 and the swiveling mechanism 126 includes the slotted bushing 1104. The opposite side of the housing 1136 for the swiveling mechanism 126 is open to allow the swiveling member 114 to move in an arc 416 with the bracket 1112 and stop connector 1108 joint as a pivot.

The distal end of the swiveling member 114 has the imaging module 130. Adjacent the imaging module 136 and attached to the swiveling member 114 are a pair of expansion springs 1154-R, 1154-L and a pair of solenoids 1142-R, 1142-L. The right solenoid 1142-R includes an actuator 1144-R affixed to the right sidewall 1138-R of the housing 1136 for the swiveling mechanism 124. The right solenoid 1142-R also includes a plunger 1146-R that moves linearly inward and outward 1148-R. The expansion spring 1152-R is connected at one end to the plunger 1146-R and at the other end to a link 1154-R that is connected the distal end 1156 of the swiveling member 114. The left solenoid 1142-L includes an actuator 1144-L affixed to the left sidewall 1138-L of the housing 1136 for the swiveling mechanism 124. The left solenoid 1142-L also includes a plunger 1146-R that moves linearly inward and outward 1148-L. The expansion spring 1152-L is connected at one end to the plunger 1146-L and at the other end to a link 1154-L that is connected the distal end 1156 of the swiveling member 114.

The slotted bushing 1104 includes an outer slot opening 1202 and an inner slot opening 1204. The slots 1202, 1204 are sized and dimensioned to allow the swiveling member 114 to move side-to-side, with the outer edges sloped to match the angle of the swiveling member 114 as it moves between its extreme positions 408-A1, 408-A2.

FIG. 13 illustrates a plan view of the swiveling module 122 of FIG. 11 showing the imaging module 130 swung 416-A1 to the left position 408-A1. In this configuration, the locking mechanism 124 is unlocked and the swiveling mechanism 126 is actuated to swivel to the left-actuated position 408-A1.

The locking mechanism 124 is shown in the unlocked position. The latching mechanism solenoid 1120 is actuated, thereby separating the first and second magnets 1116, 1118 and moving the swiveling member 114 away from the rotating member 112.

The swiveling mechanism 126 is shown in left-actuated position 408-A1. The left solenoid 1142-L is actuated with the plunger 1146-L moved inward 1148-L. The plunger 1146-L moves the expansion spring 1152-L leftward, thereby pulling the distal end 1156 of the swiveling member 114 leftward 416-A1. The right expansion spring 1152-R′ is shown in the expanded position, being stretched due to the leftward movement 416-A1 of the swiveling member 114.

The swiveling member 114 rotates about a pivot 1306 that is located proximate the stop connector 1306 and bracket 1112. In one embodiment, the bracket 1112 has an opening that receives the swiveling member 114 and the bracket 1112 is sandwiched between the stop connector 1108 and the spring 1106. As the distal end 1156 of the swiveling member 114 pivots leftward 416-A1, the proximal end of the swiveling member 114, which has the second magnet 1118 attached, moves rightward 1302.

When it is desired to return the imaging module 130 to its resting position 408-r, the left solenoid 1142-L of the swiveling mechanism 126 is de-energized, allowing the swiveling member 114 to return to its resting position 408-r. With the swiveling member 114 at its resting position 408-r, the latching mechanism solenoid 1120 is de-energized, allowing the swiveling member 114 to retract towards the rotating member 112.

FIG. 14 illustrates a functional block diagram of the electrical connections of the camera assembly 100. A controller 1402 provides electrical control and power to the various components of the camera assembly 100. The controller 1402 is connected to a processor 1404 that is, in turn, connected to a user interface device 1406. FIG. 14 shows the electrical connections for a single rotating arm 104. Those skilled in the art will recognize that the number of electrical connections will vary without departing from the spirit and scope of the present invention.

The controller 1402 is connected directly to the rotary drive 202. For the embodiment of the rotary drive 202-A with a solenoid 506, the controller 1402 actuates the solenoid actuator 508 as needed.

The controller 1402 is connected to components 120, 122, 130 on each rotating arm 104 by way of the brushes 212 contacting the conductive traces 302 on the rotating disc 140. The controller 1402 is in electrical communication with the rotation module 120, the locking mechanism 124, the swiveling mechanism 126, and the imaging module 130.

In the illustrated embodiment, the controller 1402 is a device that receives input from the processor 1404 and converts those inputs to outputs sufficient to control and drive the rotary drive 202, the rotation module 120, the locking mechanism 124, the swiveling mechanism 126, and the imaging module 130.

As used herein, the processor 1404 should be broadly construed to mean any computer or component thereof that executes software. In one embodiment, the processor 1404 is a specialized device for implementing the functions of the invention. In one embodiment, the controller 1402 and the processor 1404 are integrated into a single device that performs the functions of both the controller 1402 and the processor 1404. In another embodiment, the processor 1404 is incorporated into the camera assembly 100. In yet another embodiment, the processor 1404 is remote from the camera assembly 100 and communicates with the controller 1402 via wired or wireless connection.

The processor 1404 includes a memory medium that stores software, a processing unit that executes the software, and input/output (I/O) units for communicating with external devices. Those skilled in the art will recognize that the memory medium associated with the processor 1404 can be either internal or external to the processing unit of the processor without departing from the scope and spirit of the present invention.

The user interface 1406 allows for interaction with the user. In various embodiments, the interaction includes data entry, display of data, and display of the image output from the at least one imaging modules 130. In one embodiment, the user interface 1406 is incorporated in a mobile device that also incorporates the camera assembly 100. In another embodiment, the user interface 1406 is remote from the camera assembly 100 and communicates with the controller 1402 and/or the processor 1404 via wired or wireless connection.

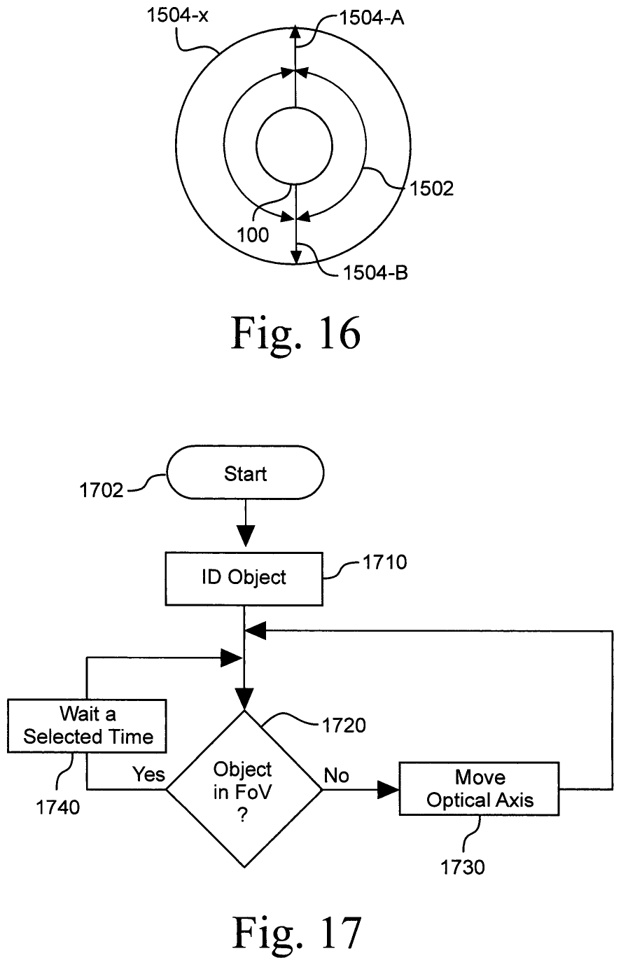

FIG. 15 illustrates a symbolic side view of one embodiment of the camera assembly 100 showing a field of view 1502. FIG. 16 illustrates a symbolic front view of one embodiment of the camera assembly 100 showing a field of view 1502. With the imaging sensor 130 of the camera assembly 100 in a default, resting position 408-r, the optical axis 234 extends outward perpendicular to the plane of the rotating disc 140.

Operation of the rotary drive 202, the rotation module 120, the locking mechanism 124, and the swiveling mechanism 126 moves the optical axis 234 of the imaging module 130 to move between two extreme directions 1504-A, 1504-B. In the illustrated embodiment, the two extreme directions 1504-A, 1504-B are in opposite directions, 180 degrees apart in all directions around a plane perpendicular to the optical axis 234 in the default, resting position 408-r. The extreme directions 1504-A, 1504-B sweep around the resting optical axis 234. The field of view 1502 in the illustrated embodiment allows the optical axis 234 to be pointed anywhere within a hemispherical volume. That is, the illustrated field of view 1502 encompasses a hemisphere extending from the rotating disc 144. In the embodiment where the imaging module 130 includes front and rear imaging sensors 232-F, 232-R, the field of view 1502 substantially encompasses a sphere.

FIG. 15 shows an object 1512 that is some distance away from the camera assembly 100. In this case the object 1512 represents a truck that may be moving. The object 1512 is within the field of view 1502 and is in the line of sight 1510 of the camera assembly 100.

FIG. 17 illustrates a functional flow block diagram of the steps for keeping an object 1512 within a field of view 1502 of the camera assembly 100. The imaging module 130 in the camera assembly 100 moves. Additionally, the camera assembly 100 itself moves, such as when a portable device to which the camera assembly 100 is mounted, is physically moved. The camera assembly 100 tracks the movement of the object 1512 relative to the camera assembly 100, thereby accommodating movement of the object 1512 and movement of the camera assembly 100.

The first step 1702 is to start the process. When the process is started, the step 1710 of identifying the object 1512 of interest is performed. Referring to FIG. 15, the object 1512 of interest is a truck 1512. In one embodiment, the identification step 1710 is performed manually by an operator viewing an image stream from the camera assembly 102 and identifying the object 1512 as one to be followed. In such an embodiment, the user interface 1406 allows the user to perform the identification step 1710. In another embodiment, the processor 1404 or other processing equipment executes a program that analyzes the image from the camera assembly 100 to determine if the image of the field of view 1502 contains any objects 1512 that should be tracked.

The next step 1720 is to determine if the object 1512 of interest is in the field of view 1502. In one embodiment, the processor 1404 or other processing equipment executes a program that compares the location of the object 1512 to the optical axis 234 of the imaging module 130. The program calculates the deviation between the location of the object 1512 in the field of view 1502 and the optical axis 234 and sends data to the camera assembly 100 to move the imaging module 214 so that the object 1512 remains in the field of view 1502.

If the step 1720 determines that the object 1512 is in the line of sight 1510 within the field of view 1502, then no image module 130 movement is necessary and the process loops. In the illustrated embodiment, a step for waiting a selected time 1740 is performed. The time delay is selected to be long enough to minimize processor load and to be short enough to ensure that the object 1512 does not move out of the field of view 1502.

If the step 1720 determines that the object 1512 is moving within the field of view 1502, then movement of the imaging module 130 is necessary. In that case, the step 1730 of moving the optical axis 234 by moving the imaging module 130 is performed. After step 1730 is performed, the process loops back to step 1720 to determine if the object 1512 is within the field of view 1502.

From the foregoing description, it will be recognized by those skilled in the art that a dynamic camera system 100 has been provided. The dynamic camera system 100 includes at least one imaging module 130 at the end of a rotating arm 104, where that imaging module 130 includes at least one imaging sensor 234 that moves so as to sweep a wide field of view.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for a dynamic camera system, said apparatus comprising:
a rotating disc configured to rotate about a disc axis, said rotating disc having a first surface and a second surface;
a first rotation module connected to said rotating disc, said first rotation module having an output that rotates about a longitudinal axis;
a first swiveling module connected to said output of said first rotation module, said first swiveling module having a first swiveling module output that swivels relative to said longitudinal axis;
a first imaging module connected to said first swiveling module output of said first swiveling module, said first imaging module having a field of view that encompasses a hemisphere extending from said rotating disc; and
a first rotating arm defined by said first rotation module, said first swiveling module, and said first imaging module, said first rotating arm attached to said rotating disc, said first rotating arm positioned proximate said first surface of said rotating disc.

2. The apparatus of claim 1 further including a rotary drive configured to rotate said rotating disc about a rotation axis.

3. The apparatus of claim 2 wherein said rotary drive includes a spring and a speed control device.

4. The apparatus of claim 1 wherein said second surface of said rotating disc includes a plurality of conductive traces electrically connected to said first rotating arm on said first surface of said rotating disc; and further including a plurality of brushes each making electrical contact with an associated one of said plurality of conductive traces as said rotating disc rotates.

5. The apparatus of claim 1 further including a user interface, a processor, and a controller; said user interface communicating with said processor, said processor executing instructions for causing said controller to operate said first rotation module, said first swiveling module, and said first imaging module.

6. The apparatus of claim 1 further including a second rotating arm attached to said rotating disc, said second rotating arm having a second fixed member and including a second rotation module, a second swiveling module connected to said second rotation module, and a second imaging module connected to said second swiveling module.

7. The apparatus of claim 1 wherein said first rotating arm includes a fixed member, said first rotation module, a first rotating member, said first swiveling module, a first swiveling member, and said first imaging module; wherein a first end of said fixed member is attached to said rotating disc and a second end is attached to an input of said first rotation module; a first end of said first rotating member is attached to said output of said first rotating member and a second end is attached to an input of said first swiveling module; and a first end of said first swiveling member is attached to said first imaging module and a second end is attached to said first imaging module.

8. The apparatus of claim 1 wherein said first rotation module includes a rotating member with a first spring engaging said rotating member, a first solenoid operatively connected to said first spring whereby, when said first solenoid is energized, said first solenoid causes said rotating member to rotate in a first direction; said first rotation module includes a second spring engaging said rotating member; and a second solenoid operatively connected to said second spring whereby, when said second solenoid is energized, said second solenoid causes said rotating member to rotate in a second direction.

9. The apparatus of claim 1 wherein said first rotation module includes a rotating member with a crankshaft configuration, a first solenoid, and a second solenoid; said first solenoid engaging a first crank pin defined in said rotating member whereby, when said first solenoid is energized, said first solenoid causes said rotating member to rotate in a first direction; and said second solenoid engaging a second crank pin defined in said rotating member whereby, when said second solenoid is energized, said second solenoid causes said rotating member to rotate in a second direction.

10. The apparatus of claim 1 wherein said first swiveling module includes a locking mechanism and a swiveling mechanism; said locking mechanism including a pair of magnets movable between a locked position whereby said pair of magnets are held together by a magnetic force and an unlocked position whereby said pair of magnets are separated; said swiveling mechanism holding said imaging module in a center position when said locking mechanism is in said locked position; and said swiveling mechanism moving said imaging module between opposite actuated positions.

11. The apparatus of claim 1 wherein said imaging module is operated to identify an object in said field of view of said first imaging module and to keep said object in said field of view by moving an optical axis of said first imaging module.

12. An apparatus for a dynamic camera system, said apparatus comprising:
a rotating disc configured to rotate about a disc axis, said rotating disc having a first surface and a second surface, said second surface of said rotating disc including a plurality of conductive traces electrically connected to conductive paths on said first surface;
a rotary drive configured to rotate said rotating disc about a rotation axis;
a first rotating arm attached to said rotating disc, said first rotating arm rotating in conjunction with the rotation of said rotating disc, said first rotating arm having a fixed member attached to said rotating disc;
a first rotation module connected to said fixed member of said first rotating arm, said first rotation module including a rotating member that rotates about a longitudinal axis;
a first swiveling module connected to said rotating member extending from said first rotation module, said first swiveling module having a first swiveling member extending from said first swiveling module, said first swiveling member swivels in an arc relative to said longitudinal axis; and
a first imaging module connected to said first swiveling member extending from said first swiveling module, said first imaging module having a field of view that encompasses a hemisphere extending from said rotating disc.

13. The apparatus of claim 12 wherein said first rotation module includes a first spring engaging said rotating member and a first solenoid operatively connected to said first spring whereby, when said first solenoid is energized, said first solenoid causes said rotating member to rotate in a first direction; and said first rotation module further includes a second spring engaging said rotating member and a second solenoid operatively connected to said second spring whereby, when said second solenoid is energized, said second solenoid causes said rotating member to rotate in a second direction.

14. The apparatus of claim 12 wherein said rotating member includes a crankshaft configuration; said first rotation module includes a first solenoid and a second solenoid; said first solenoid engaging a first crank pin defined in said rotating member whereby, when said first solenoid is energized, said first solenoid causes said rotating member to rotate in a first direction; and said second solenoid engaging a second crank pin defined in said rotating member whereby, when said second solenoid is energized, said second solenoid causes said rotating member to rotate in a second direction.

15. The apparatus of claim 12 wherein said first swiveling module includes a locking mechanism and a swiveling mechanism; said locking mechanism having a locked position whereby said first swiveling member is held in a center position; said locking mechanism having an unlocked position whereby said first swiveling member is movable to swing said imaging module away from said longitudinal axis.

16. The apparatus of claim 15 wherein said locking mechanism includes a pair of magnets whereby said pair of magnets are held together by a magnetic force when said locking mechanism is in said locked position.

17. The apparatus of claim 12 wherein said imaging module is operated to identify an object in said field of view of said first imaging module and to keep said object in said field of view by moving an optical axis of said first imaging module.

18. The apparatus of claim 12 further including a processor and a controller; said processor executing instructions for causing said controller to operate said rotary drive, said first rotation module, said first swiveling module, and said first imaging module.

19. The apparatus of claim 18 wherein said processor executes a plurality of steps to keep an object within said field of view; said plurality of steps includes a) identifying said object; determining if said object is in field of view; waiting a selected time if said object is in said field of view; and moving an optical axis of said first imaging module if said object is moving out of said field of view.

20. The apparatus of claim 12 further including a plurality of brushes each making electrical contact with an associated one of said plurality of conductive traces as said rotating disc rotates.
